(19) United States
(12) Patent Application Publication
(10) Pub. No.: US 2010/0188293 A1
(43) Pub. Date: Jul. 29, 2010

(54) Plane Antenna

(75) Inventor: Chin-Wei Ni, Taipei City (TW)

Correspondence Address: WPAT, PC;INTELLECTUAL PROPERTY ATTORNEYS, 7225 BEVERLY ST., ANNANDALE, VA, 22003, US

(73) Assignee: SERCOMM CORPORATION, Taipei City (TW)

(21) Appl. No.: 12/360,632

(22) Filed: Jan. 27, 2009

(51) Int. Cl. H01Q 1/38

(52) U.S. Cl. 343/700 MS

(57) ABSTRACT

A wireless internet with a plane antenna, the plane antenna comprising: a plane, an import antenna, a plurality of radiator and an export antenna. The plane has an edge; the import antenna is located the plane, the import antenna has a first import line and a second import line, a point of the first import antenna connects with the edge, and the point is perpendicular to the edge, the second import line and the first import connect with each other to have an included angle; the plurality of radiator has a preview arrangement method to connect with the plane, each radiator has a first conducting wire, a sharp part, a first protruding fringe, a fillister, a second protruding fringe and a second conducting wire; the export antenna is located the plane, the export antenna has a first export antenna and a second export antenna, the second export line and the first export line connect with each other to have the included angle. Wherein the second import line and the second export line connect with different the first conducting wire of the radiator.

### FIELD OF THE INVENTION

The present invention relates to a plane antenna, particularly, a wireless Internet apparatus with the plane antenna.

### BACKGROUND OF THE INVENTION

Referring to FIG. 1 is a solid schematic view of a topic wireless Internet apparatus 10 with a plane antenna. The wireless internet apparatus is provided for a substance 11, an interior electric circuit apparatus of the substance interior 12, a point of the substance of a connector part 13 connects with a exterior host (non-shown) and the substance 11 is compared to another a antenna signal receive part 14. Generally, the antenna signal received part 14 of a case is composed of the non-metal material and the wireless Internet apparatus 10 connects with the exterior host. The antenna signal received part 14 needs to expose the exterior part of the exterior host for receiving wireless signal effectively.

For the users convenient, referring to FIG. 1 for X-Y flat has the higher wireless signal transmission effectively. However, the dead corner of the plane of the radiation pattern of the topic wireless network device 10 on the X-Y plane is higher. For example, FIG. 2 is shown as the FIG. 1 is that the topic wireless network device of the X-Y plane analyses the radiation pattern. The radiation pattern of FIG. 2, the average gain value only has −4.3 dBi of the topic wireless network device 10. Another, the FIG. 3 is shown as the FIG. 1 is shown the topic wireless network device analyses the loss of a round trip pattern. The loss of a round trip pattern of the FIG. 3, around the 2.4 GHz˜2.5 GHz of frequency range, the loss of a round trip of the topic network device is about −12.6 dB; a value is much higher than frequency antenna design of a round trip of the general market is lower than −10 dB request. Obviously, there are further step of the improvement.

Therefore, the antenna designs of the wireless internet apparatus 10. Now, how we have to raise the isolation between each antenna on the direction of the X-Y flat and to reduce the dead corner at the radiation pattern for improving the X-Y flat receiving capability.

### SUMMARY OF THE INVENTION

The primary objective of the present invention is to provide a plane plane; it raises the effeteness and reduces the dead corner at the radiation pattern to avoid the interference and to raise the antenna effective.

The above-mentioned, a preferred embodiment of a wireless Internet apparatus with the plane antenna in accordance with the present invention is included: a plane, an import line, a plurality of radiator and an exterior line. The plane has an edge; the import antenna is located the plane, the import antenna has a first import line and a second import line, a point of the first import antenna connects with the edge, and the point is perpendicular to the edge, the second import line and the first import connect with each other to have an included angle; the plurality of radiator has a preview arrangement method to connect with the plane, each radiator has a first conducting wire, a sharp part, a first protruding fringe, a fillister, a second protruding fringe and a second conducting wire; the export antenna is located the plane, the export antenna has a first export antenna and a second export antenna, the second export line and the first export line connect with each other to have the included angle. Wherein the second import line and the second export line connect with different the first conducting wire of the radiator.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a schematic solid view of the design of an antenna.

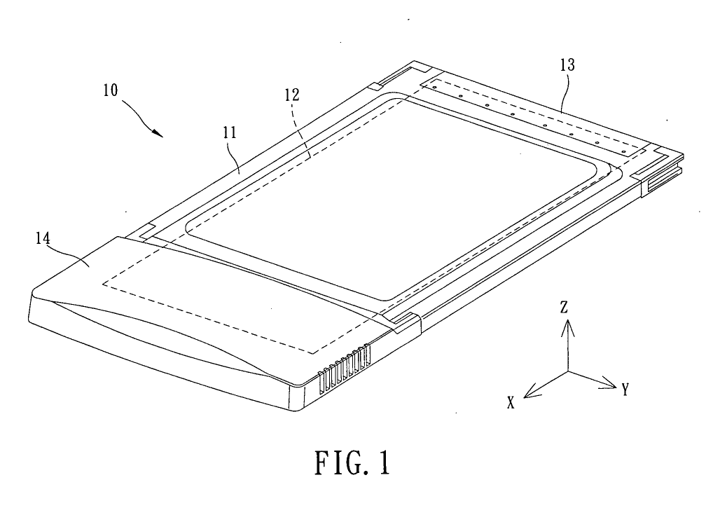

FIG. 2 is shown as the FIG. 1 of the topic wireless network device of the X-Y plane analysis of the radiation pattern.

FIG. 3 is shown as the FIG. 1 of the loss of a round trip pattern of the topic wireless network device.

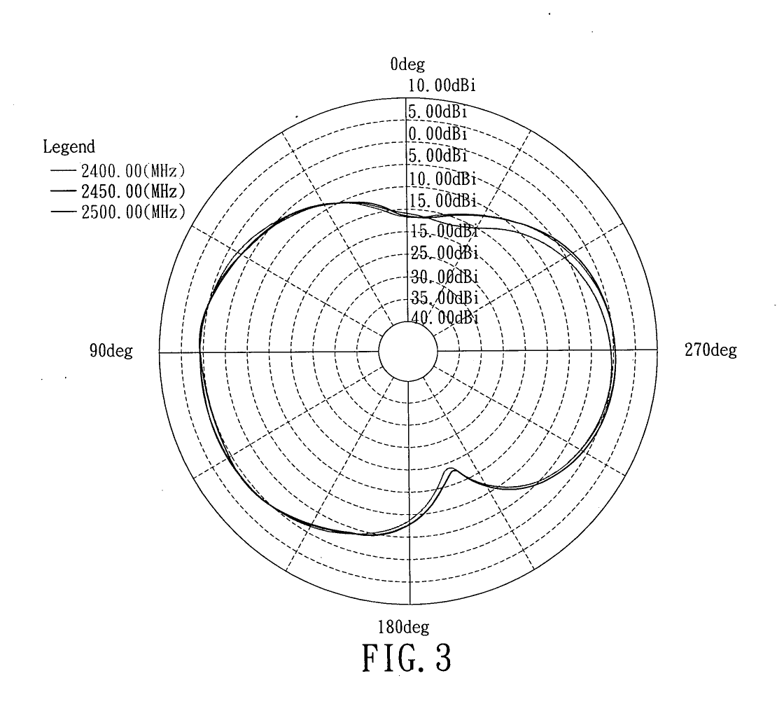

FIG. 4 is a schematic view of the plane antenna in accordance with preferred embodiment.

FIG. 5 is shown as the FIG. 4 of the invention of the X-Y plane analysis of the radiation pattern of the plane antenna.

FIG. 6 is shown as the FIG. 4 of the invention of the loss of a round trip of plane antenna pattern.

### DETAILED DESCRIPTION OF THE PREFERRED EMBODIMENTS

In the related figures of a preferred embodiment, the same referring numerals are used for the same components of an input apparatus in accordance with the present invention.

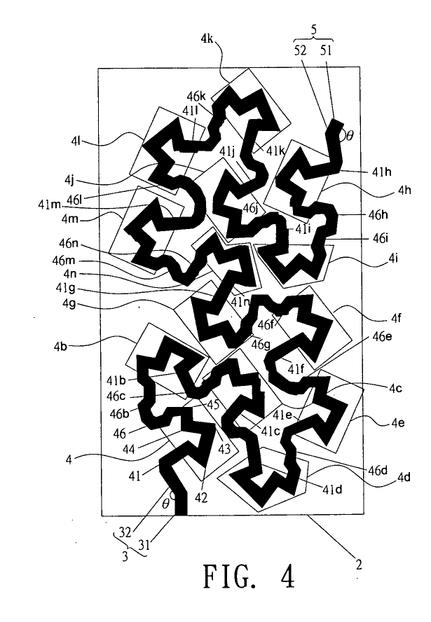

Referring to FIG. 4 for a schematic view of an plane antenna provided for processing a wireless internet apertures in accordance with the present invention, the plane antenna is composed of a substance 2, a import antenna 3, a plurality of radiator 4 and a exterior antenna 5. The substance 2 is to compose of the dielectric material and the flat configuration. The substance 2 has a numbers of the electric circuit of the surface of the circuit element. (Upon surface) and the numbers of the weld tin of the side surface of weld tin (under surface). The surface and under surface of the substance 2 at least has the first direction 91 is almost perpendicular to a first edge 21 and the second direction 92 is almost perpendicular to a second edge 22.

The import antenna 3 is located the substance 2, import antenna 3 has a first import line 31 and a second import line 32. A point of the first import line 31 connects with the first edge 21 is almost perpendicular to the first edge 21. The second import line 32 and the first import line 31 has an included angle θ. The export antenna 5 is local on the substance 2; the import antenna 5 has a first export line 51 and a second export line 52, the second export line 52 and the first export line 51 has the included angle θ.

Each radiator 4 is in order included a first conductive wire 41, a sharp part 42, a first protruding fringe 43, a fillister 44, a second protruding fringe 45 and a second conducting wire 46. A preferred embodiment of a wireless Internet apparatus with the plane antenna in accordance with the present invention is included: a plurality of radiator 4 is even numbers, and a preview arrangement method to connect with the plane and connect with each other on the substance 2. The preferred embodiment of a wireless Internet apparatus with the plane antenna in accordance with the present invention is that a plurality of radiator 4 has 14 radiators is divide two tram for a symmetrical arrangement. There are 7 radiators for a team. The connected angle of the radiator 4 is different, because the plurality of the radiator 4 has original number also add another letters of the English alphabet. The arrangement of the first radiator 4 is in order to compose to the first radiator 4 for connecting to the first conductive wire 41 and the second conductive wire 32, and the second conductive wire 46 connects with the second conductive wire 46b of the second radiator 4b. However, the first conductive wire 41b of the second radiator 4b connects with the second conductive wire 46c of the third radiator 4c. The first conductive wire 41 of the third radiator 4c connects with the first conductive wire 41d of the fourth radiator 4d. The second conductive wire 46d of the fourth radiator 4d connects with the fifth radiator 4e of the first conductive wire 41e. The second wire 46e of the fifth radiator 4e connects with the first conductive wire 41f of the sixth radiator 4f. The second team of the radiator 4 of the arrangement method corresponds with the first team radiator 4. It is order of the first conductive line 41h connects with the second export line 52 by the eighth radiator 4h; also the second conductive wire 46h connects with the second conductive wire 46i of the ninth radiator 4i. The first conductive wire 41j of the tenth radiator 4j connects with the first conductive wire 41k of the eleventh radiator 4k. The second conductive wire 46l of the twelfth radiator 41 and the second conductive wire 46m of the thirteenth radiator connect with the second wire 46n of the fourteenth radiator 4n. At least, the first conductive wire 41n of the fourteenth radiator 4n connects with the first conductive wire 41g of the seventh radiator 4g.

For manufacturing, the width of the first conductive wire 41, the width of the sharp part 42, the width of the first protruding fringe 43, the width of the fillister 44, the width of the second protruding fringe 45 and the width of second conducting wire 46 are different designs. Therefore, the X-Y flat of the antennas has better radiation pattern and gain benefits to increase the antenna efficiency.

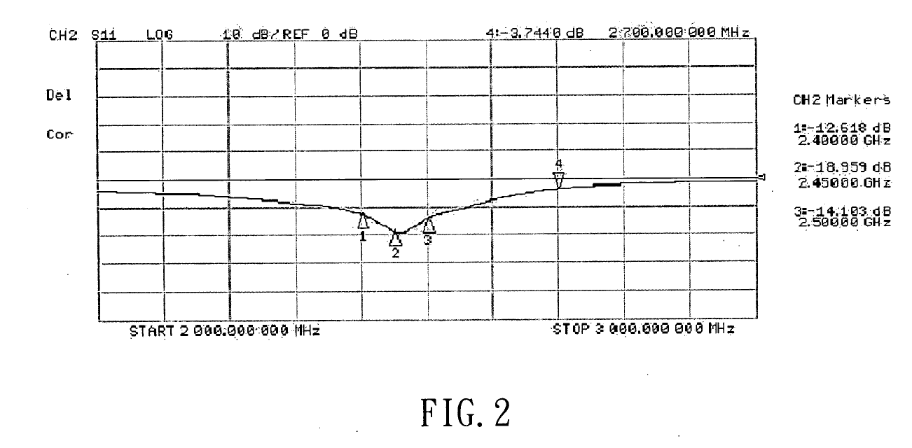

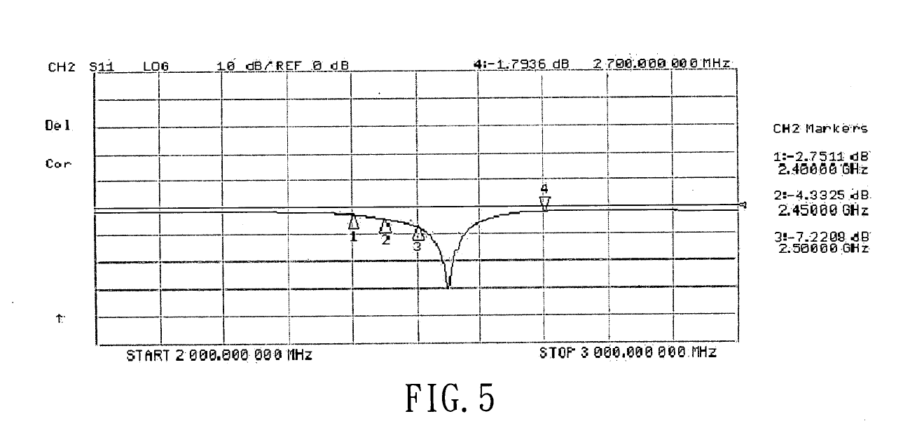

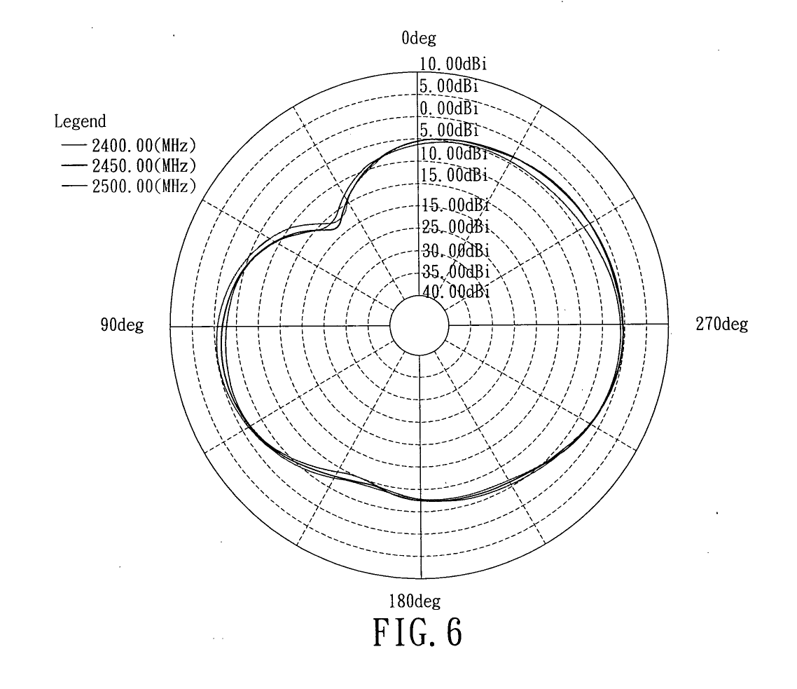

The radiation pattern of the FIG. 5, the invention of the average gain value is −4.3 dBi plane antenna; the gain efficiency has −8.44 dBi of the FIG. 2 to compare with the prior act. The FIG. 6 of the invention of the plane antenna analyses the loss of a round trip pattern. The frequency range is around 2.4 GHz˜2.5 GHz, the invention of the loss of a round trip of the plane antenna is about −2.7 dB; a value is correspond to the high efficiency antenna design of a round trip of the general market is lower than −10 dB request. To be obvious, the invention of the antenna offers the better wireless communication quality and the transmission efficiency.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless internet apparatus with a plane antenna, the plane antenna comprising:
a plane having an edge;
an import antenna located the plane, the import antenna having a first import line and a second import line, a point of the first import antenna connected with the edge, and the point perpendicular to the edge, the second import line and the first import connected with each other to have an included angle;
a plurality of radiator having a preview arrangement method to connect with the plane, each radiator having a first conducting wire, a sharp part, a first protruding fringe, a fillister, a second protruding fringe and a second conducting wire;
an export antenna located the plane, the export antenna having a first export antenna and a second export antenna, the second export line and the first export line connected with each other to have the included angle; wherein the second import line and the second export line connect with different the first conducting wire of the radiator.

2. The wireless internet apparatus with a plane antenna of claim 1, wherein the width of the first conducting wire, the width of the sharp part, the width of the first protruding fringe, the width of the fillister, the width of the second protruding fringe and the width of the second conducting wire is all different.

3. The wireless internet apparatus with a plane antenna of claim 1, wherein the plurality of radiators is even numbers.

4. The wireless internet apparatus with a plane antenna of claim 1, wherein preview arrangement method is a symmetrical arrangement.
